(19) United States
(12) Patent Application Publication
(10) Pub. No.: US 2024/0242638 A1
(43) Pub. Date: Jul. 18, 2024

(54) SEAL

(71) Applicant: SERVICE IMPEX COSTA DORADA S.L., Salou Tarragona (ES)

(72) Inventor: Alexandru CERBARI, Salou Tarragona (ES)

(21) Appl. No.: 18/562,472

(22) PCT Filed: Feb. 2, 2022
(86) PCT No.: PCT/EP2022/052496

§ 371 Date: Nov. 20, 2023

(30) Foreign Application Priority Data
May 20, 2021 (EP) 21174866.0

(51) Int. Cl. G09F 3/03; G09F 3/02

(52) U.S. Cl. CPC G09F 3/0341; G09F 2003/0223; G09F 2003/025

(57) ABSTRACT

A description is given of a seal (01) comprising a seal body (02) and a seal strip (03). At least the seal body (02) consists of a biodegradable material. The seal body (02) can be releasably connected at least to two spaced-apart portions (31, 32) of the seal strip (03) and in an operating state can be unreleasably sealed. The seal body (02) consists of two parts (21, 22), which in an operating state can be unreleasably sealably connected at least to one another. One portion (32) is arranged between the two parts (21, 22) of the seal body (02), while the other portion (31) penetrates a first part (21) of the two parts (21, 22) and can be securely connected thereto.

The invention relates to a seal according to the preamble of claim 1.

The seal comprises a seal body and a seal band. In order to withstand extreme weathering, it is made of weather-resistant material. Nowadays, this is typically metal or plastic.

When sealing, the sealing tape is laid in an arc to a bay. The sealing tape is passed through two opposite openings on elements that move away from each other when opened or operated.

The opposite openings are part of a seal, for example. After the bay has been laid in this way, the sealing tape is then fixed into a loop by means of the sealing body. The loop is dimensioned in such a way that it must be irreversibly destroyed in order to be removed. The loop must be removed, for example, to gain access to the contents of a container or to a device, or to change a setting.

The term loop in this document refers to a fixed eye in rope and/or webbing. The fixed eye does not loosen or tighten.

Because a seal can only be removed by destroying it, at best it contributes to waste generation. In the worst case, it spontaneously enters the environment. Both are detrimental to environmental protection.

DE 295 06 104 U1 describes a seal made of a cardboard material. The body of the seal and the sealing tape are in one piece. The seal tape extends from the seal body. The seal body consists of two parts that can be folded onto each other. The two parts are provided with an adhesive layer. In an operational state of the seal, the seal body can be undetachably sealed with a part of the seal tape that is spaced apart from it. In this case, the part of the sealing tape that is removed from the seal body is passed through and bonded between the two parts of the seal body.

CH 170 891 A is a known advertising seal. It consists of a seal body and an advertising mark. The body of the seal connects the incoming and outgoing parts of the seal tape.

The advertising mark frames the seal body. It covers the seal tape sections entering and leaving the seal body. The advertising mark can only be removed from the seal body after the seal has been detached.

WO 2020/157345 A1 describes a security label comprising a security band. The security tape has end pieces at its two distal ends which can be inserted into each other in a non-detachable manner. The two end pieces are of the male and female type. The securing band is made of cellulose or a derivative thereof. The end pieces are made of biodegradable plastic.

U.S. Pat. No. 6,098,253 discloses a one-piece lanyard. The lanyard is used to attach a ski pass to a skier's clothing. The lanyard is made of a biodegradable material. It has a ribbon-shaped portion with two end pieces. The end pieces are of the male/female type. To connect, the male end piece is inserted through an opening in the female end piece.

U.S. Pat. No. 3,045,303 discloses a seal with a seal body and a seal band. The seal body can consist of renewable raw materials. Renewable raw materials are, for example, organic cellulose derivatives such as cellulose ethers and cellulose esters. The seal tape can also consist of organic cellulose derivatives. These organic cellulose derivatives are, for example, plasticised cellulose acetate or cellulose acetate butyrate. The seal body is releasably connectable to at least two spaced-apart portions of the seal band. In an operating condition, the seal body is non-detachably sealable to the two spaced-apart portions of the seal tape. The seal body may comprise two parts which can be non-detachably sealably connected to each other in at least one operating state. In an embodiment in which the two parts are made of metal or semi-rigid plastic, the two parts may be resiliently hinged together by a rib. A plastic material is arranged between the two parts, which begins to flow under pressure. After the spaced sections of the seal tape have passed through the seal body and the seal tape has been tightened, the seal body is flattened by pressure. The pressure forces the plastic to contact, bind or penetrate the seal tape and the spaces between the individual fibres of the seal tape. This binds the spaced portions of the seal tape to the seal body. It also prevents relative movement of the seal tapes within the seal body. The tensile strength of the seal tapes is not significantly reduced.

The disadvantage of this seal is the complicated handling when using it.

US 2010/212117 A1 discloses a seal in the form of a cable tie made of biodegradable material. The seal is designed with a seal body and a seal band. The sealing tape is fixed on one side of the seal body. In an operating state, the seal body can be connected to a portion of the sealing tape. In the operating state, non-destructive separation of the part from the seal body is impossible. The part of the sealing strip is spaced from the seal body to the free end of the sealing strip.

The disadvantage of this seal is the possibility of lashing it in the manner of a cable tie. This means that the seal tape does not form a fixed eye. Instead, the eye can be subsequently reduced. This can be done intentionally or unintentionally. The eye can be reduced to a size that is smaller than the maximum movement range of the seal.

If the eye is subsequently reduced, this can lead to unintentional and uncontrolled destruction of the seal.

US 2004/032332 A1 also discloses a seal in the form of a cable tie made of biodegradable material. The seal is designed with a seal body and a seal band. The sealing tape is fixed on one side of the seal body. The seal body can be connected to a part of the sealing tape in an operating state. The part is spaced from the seal body to the free end of the seal band. The connection is designed in such a way that non-destructive separation of the part from the seal body is impossible. In order to prevent lashing, an adhesive can be introduced or released into the lead-through for the free end of the sealing tape in the seal body.

The disadvantage of this seal is that it is much more difficult to handle. Handling is made difficult by the introduction or release of adhesive into the lead-through of the seal tape in the seal body.

Another disadvantage is the considerably reduced environmental compatibility of the seal. The environmental compatibility is considerably reduced because adhesive can escape uncontrolled into the environment during storage and handling of the seal.

FR 2 799 864 A1 discloses a seal with a seal body and a seal band. The seal consists of a plastic band with an attachment of male and female connections. These cannot be opened without destroying the seal. The seal band is fixed on one side of the seal body. The seal body consists of two parts that can be connected to each other in a non-detachable manner in at least one operating state. The two parts are hinged to each other. The two parts that can be connected to one another in a manner that cannot be detached and sealed in an operating state can be bonded to one another. For this purpose, an adhesive layer is arranged between the parts that are non-detachably sealably connected to each other in an operating state.

The disadvantage of the filigree construction is that the free end of the sealing tape already comes into contact with the adhesive layer before the seal body is completed by folding the two hinged parts onto each other.

Alternatively, the disadvantage of the filigree construction is that the free end of the sealing tape is already blocked during insertion into the seal body.

Also, the construction of the seal does not allow satisfactory adjustment of the width of the eye to be made after the free end of the seal band has been inserted into the seal body. This has to be done beforehand by shortening the free end. This makes the handling of the seal considerably more difficult. Furthermore, it cannot be ensured that when the free end is shortened, the accumulating section of the seal tape is introduced into the environment in a controlled manner.

An adhesive seal is known from U.S. Pat. No. 2,639,479. The adhesive seal consists of a bottom flap, a top flap and a security band. The bottom flap is provided with a feed-through opening for the ends of the securing tape. The top flap is hinged to the bottom flap. The feed-through opening can be designed as a slot worked in from the edge of the bottom flap or as a central hole. A strap, such as a parcel or gift ribbon) is placed with its free ends through the grommet opening.

By folding the upper flap onto the lower flap, the two sections of the tape are fixed in place by the adhesive layer located on the side of the lower flap facing the upper flap.

On the side of the bottom flap facing away from the top flap, an adhesive layer is arranged to fix the adhesive seal with the tape to the parcel or gift.

The disadvantage here is the adhesion to the object to be sealed, for example a reusable container. This means that the object has to be cleaned after the seal has been removed. This goes hand in hand with unnecessary environmental pollution.

It is the task of the invention to create an environmentally compatible seal with improved handling and improved protection against subsequent modification.

The task is solved by the features of claim 1.

Advantageous embodiments of the invention are shown in the subclaims.

In any case, the invention is realised if it concerns a seal with a seal body as well as a seal band, which preferably consist of biodegradable material.

Particularly preferably, the biodegradable material consists at least partially of self-compostable material.

By using a biodegradable material at least for the seal body, the environmental balance of the seal is considerably improved compared to the state of the art. If the seal is spontaneously introduced into the environment, it composts by itself over time. If it is disposed of properly, for example in household or commercial waste, its independent compostability ensures a reduction in the total amount of waste.

Additional advantages over the state of the art that go beyond the complete solution of the set task and/or the advantages mentioned above are listed below.

The invention is explained in more detail below using examples of embodiments shown in the drawing. The proportions of the individual elements in relation to each other in the figures do not always correspond to the real proportions. Some shapes are simplified and other shapes are shown enlarged in relation to other elements for better illustration. Identical reference signs are used for elements of the invention that are identical or have the same effect. Furthermore, for the sake of clarity, only reference signs necessary for the description of the respective figure are shown in the individual figures. The embodiments shown are merely examples of how the invention may be configured and do not represent a conclusive limitation. They show in schematic representation:

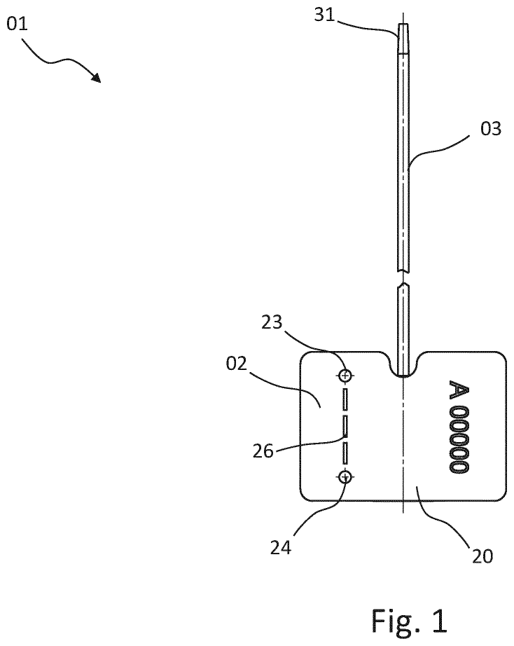

FIG. 1 a first embodiment of a seal in the initial state and top view, on its first flat side,

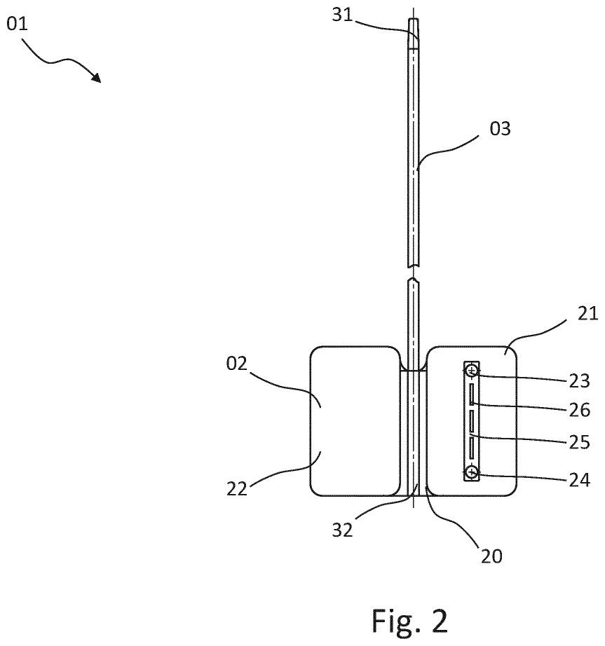

FIG. 2 the seal from FIG. 1 in the opposite flat side,

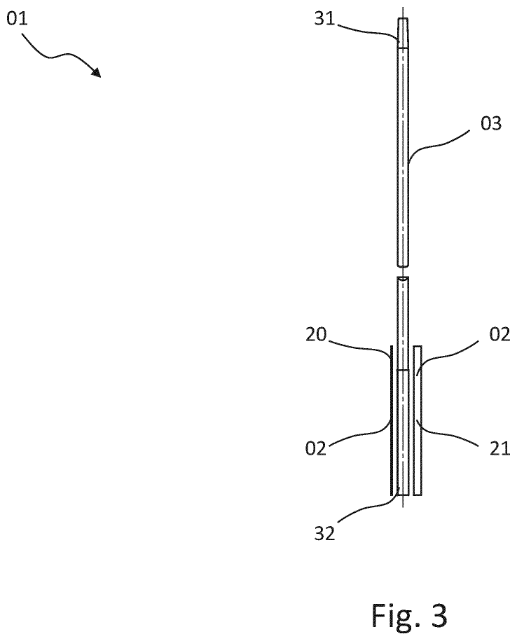

FIG. 3 the seal from FIG. 1 in the initial state in a side view of its long side,

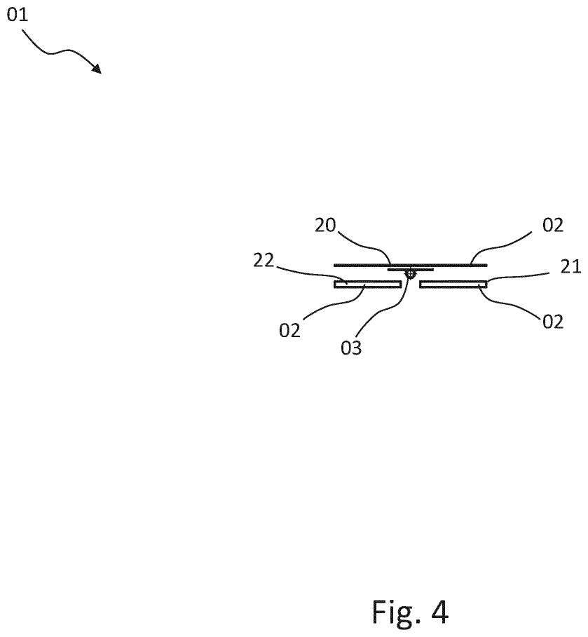

FIG. 4 the seal from FIG. 1 in the initial state in a side view of its narrow side,

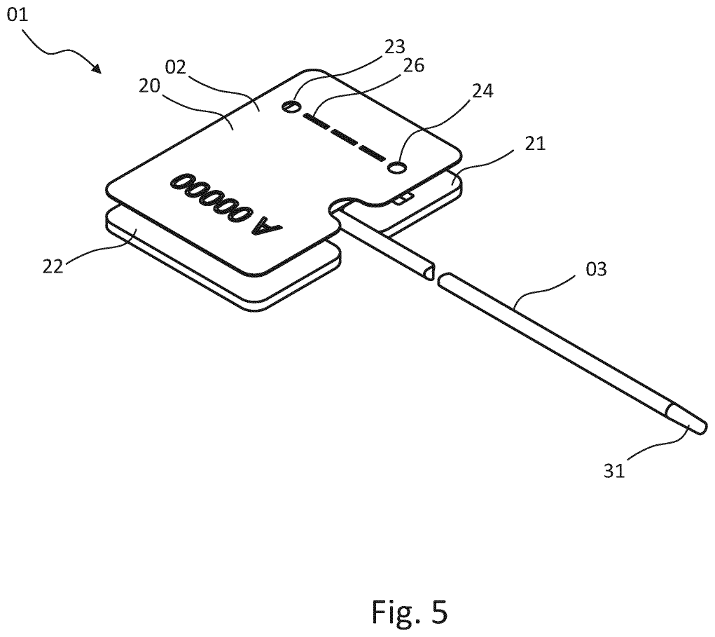

FIG. 5 The seal from FIG. 1 in the initial state in a perspective view,

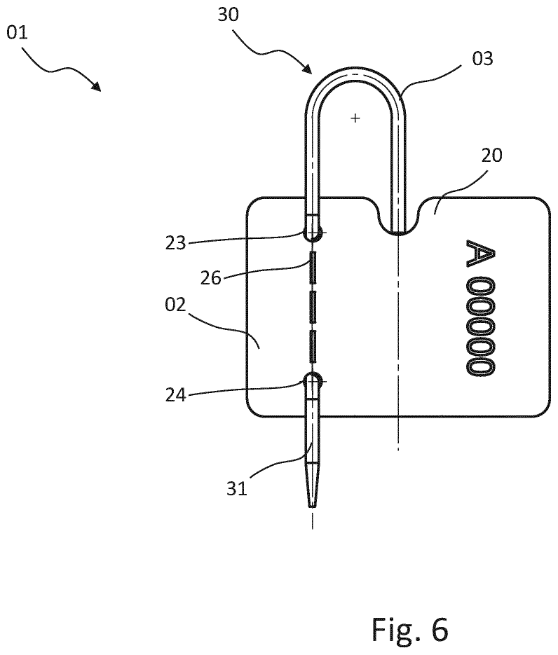

FIG. 6 Seal according to FIG. 1 converted into an intermediate state in a top view of its first flat side,

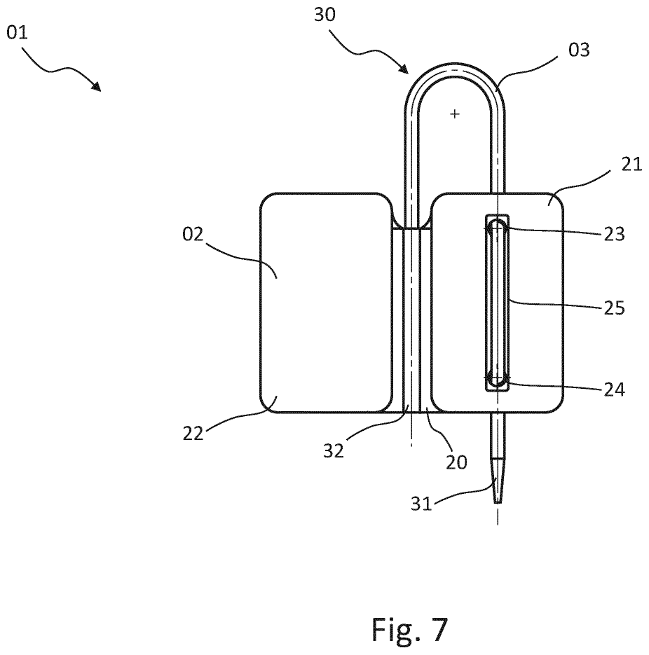

FIG. 7 the seal from FIG. 6 in the intermediate state in a top view,

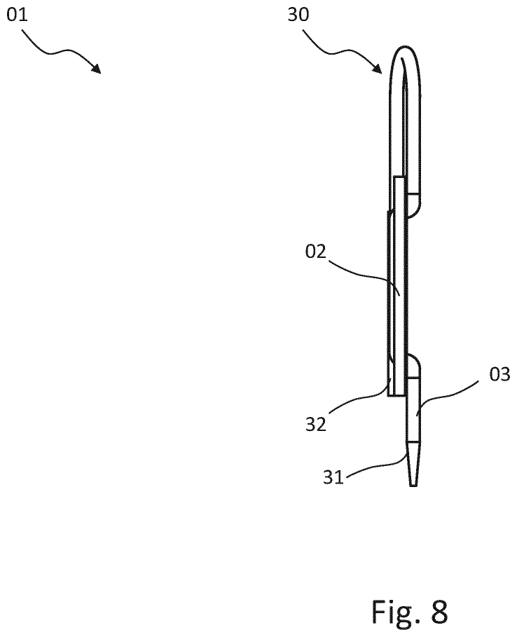

FIG. 8 the seal from FIG. 6 in the intermediate state in a side view of its long side,

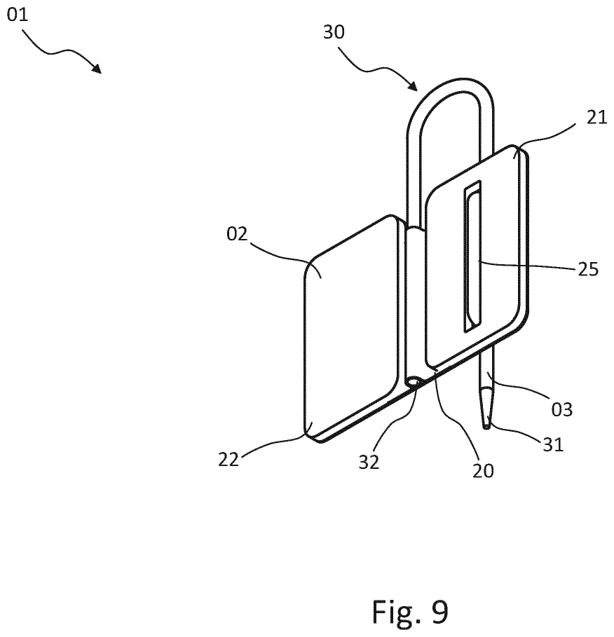

FIG. 9 The seal from FIG. 6 in the intermediate state in a perspective view,

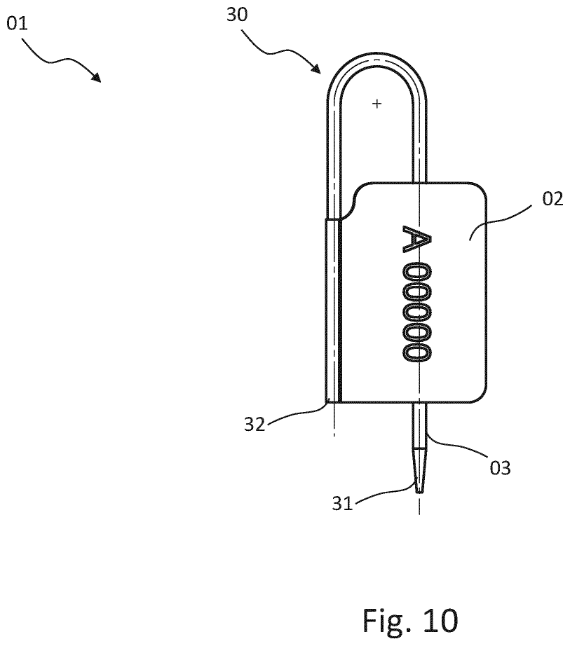

FIG. 10 the seal from FIG. 6 transferred from the intermediate state in a top view, in its first flat side,

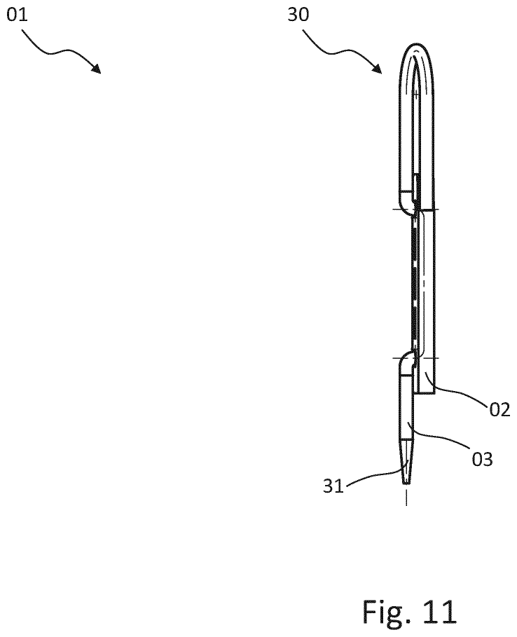

FIG. 11 the seal from FIG. 10 in the operating state in a side view of its long side,

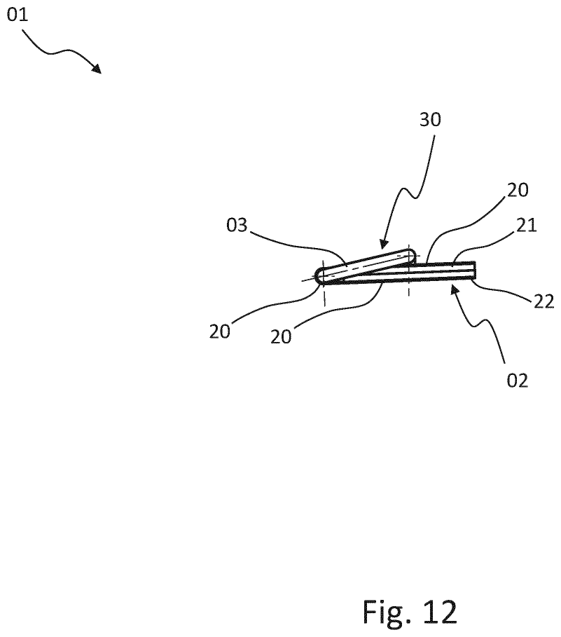

FIG. 12 the seal from FIG. 10 in the operating state in a side view of its narrow side,

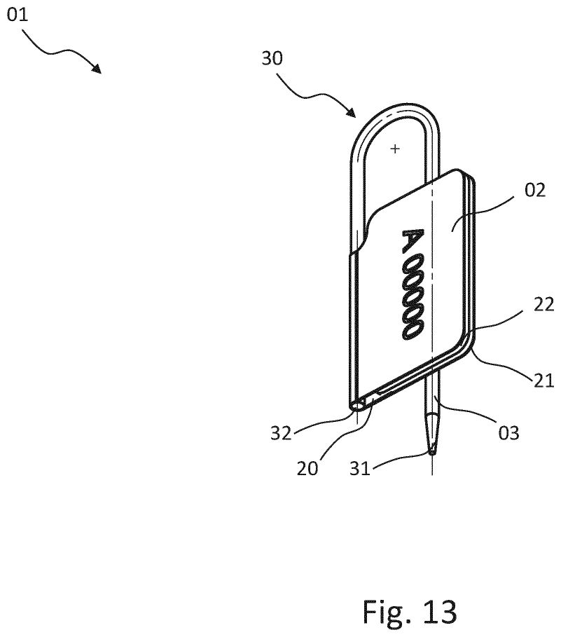

FIG. 13 The seal from FIG. 10 in the operating state in a perspective view,

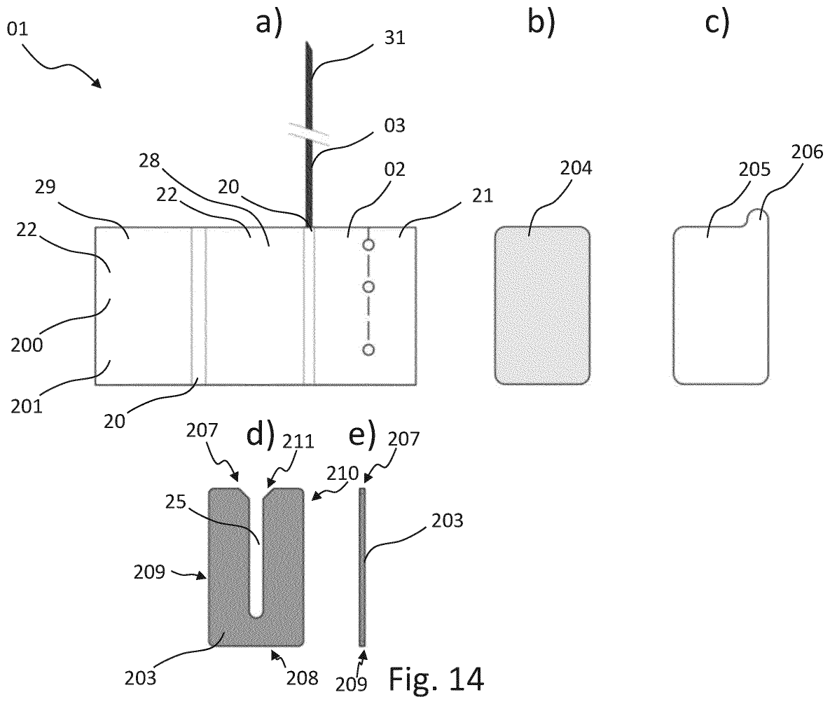

FIG. 14 the individual parts of a seal according to a second embodiment:
FIG. 14a a top view of a seal body in the unfolded state
FIG. 14b a first seal core adhesive sheet in a top view,
FIG. 14c a second seal core adhesive sheet in a top view,
FIG. 14d a seal core in a top view and
FIG. 14e the seal core from FIG. 14d in a side view

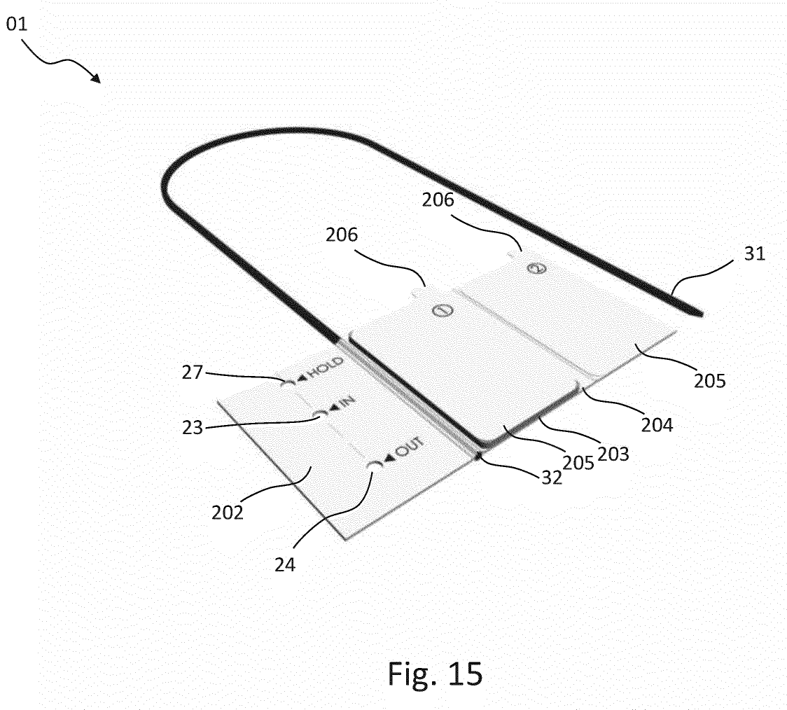

FIG. 15 the seal from FIG. 14 in an initial state in its first flat side and

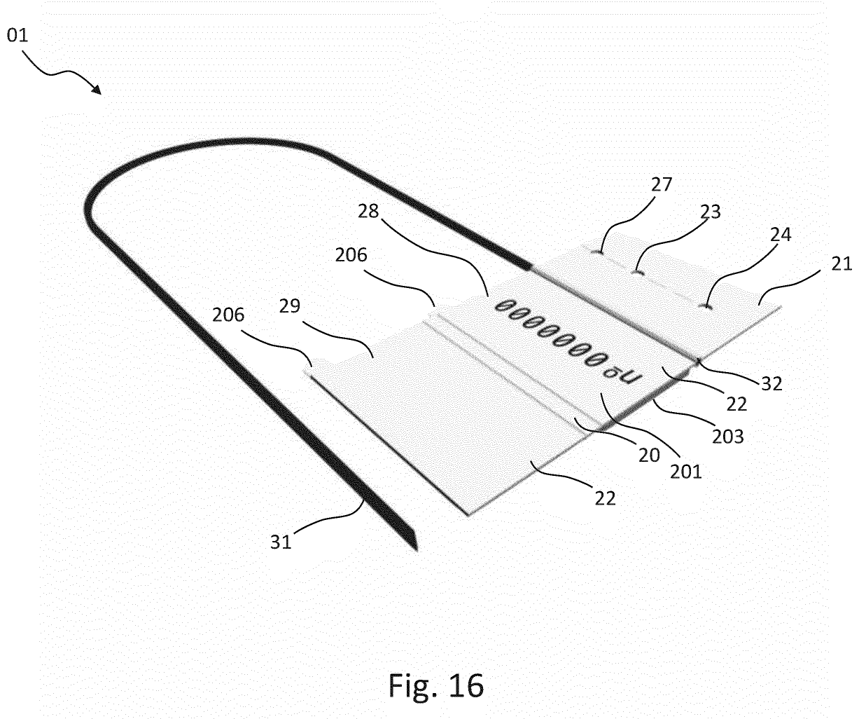

FIG. 16 the seal from FIG. 14 in the initial state in a perspective view of its flat side opposite its first flat side.

A seal 01 shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16 comprises in whole or in part:
a seal body 02 and
a seal band 03 which, starting from an initial state (FIG. 1, FIG. 2, FIG. 3, FIG. 4, FIG. 5, FIG. 15, FIG. 16), can be laid on the seal body 02 to form a loop 30 for transfer to an intermediate state (FIG. 6, FIG. 7, FIG. 8, FIG. 9) and can be connected to the seal body 02 in an operational manner to obtain an operational state (FIG. 10, FIG. 11, FIG. 12, FIG. 13).

At least the seal body 02 consists of a biodegradable material.

Preferably, at least the seal body 02 is made of one or more biodegradable materials.

Preferably, all functional parts of the seal 01 consist of one or more biodegradable materials.

Particularly preferably, the entire seal 01 consists of one or more biodegradable materials.

In other words, the seal 01 comprises the seal band 03 as a flexible means having two end portions 31, 32 operatively connectable to the seal body 02.

The seal 01 can also be called a seal.

The flexible means can be designed as a flexible strip.

The flexible means and/or the flexible strip can be formed as a rope and/or a chain.

The flexible means and/or the flexible strip may comprise a rope and/or a chain.

The seal 01 is characterised in that, for example, at least the functional parts of the seal 01 are made of biodegradable material.

Biodegradable materials, BAWs for short, must degrade within 6-10 weeks in a large-scale composting operation. The testing of BAWs is carried out by the DIN standard EN 13432. They do not necessarily have to consist of biological raw materials. Examples are so-called starch blends, for example corn-based, or certain polyesters.

The biodegradable material may be a biodegradable plastic. For example, it is a biodegradable and bio-based plastic.

Preferably, the biodegradable material is a naturally occurring, compostable material.

Particularly preferably, the biodegradable material consists at least partially of self-compostable material.

Composting, also known as rotting, is described as part of the nutrient cycle. In this process, the organic material is decomposed by soil organisms under the influence of atmospheric oxygen. In addition to carbon dioxide, water-soluble minerals are also released. These act as fertiliser. Some of the intermediate products produced during this decomposition are converted into humus.

The biodegradable material can be, for example, the following materials:
a biodegradable plastic, and/or
a biodegradable and bio-based plastic, and/or
a solid material of the polylactic acid, and/or
Cellulose, and/or
Cellulose ester, and/or
Celluloid

Alternatively or additionally, the biodegradable material may be based on the aforementioned variants. Alternatively or additionally, the biodegradable material may comprise the said variants.

Advantageously, in all the embodiments described, the seal body 02 referred to as the base may be made entirely or partly of a waterproof material, namely cellulose-based.

Alternatively or additionally, the base or parts of it may be made of waterproof paper or cardboard.

The sealing tape 03 can be a flexible or bending elastic tape. Alternatively, it is conceivable that it is a flexible band.

The sealing tape 03, for example in the form of a flexible element that can be tightened into a loop, can be a thread, a cord or a ribbon, and it can be made of vegetable raw materials.

The sealing tape 03 may alternatively or additionally be made of natural, bio-based biodegradable polymer.

In principle, the seal body and the seal tape can be made of the same biodegradable material.

Any adhesive strip provided for sealing may also comprise a bio-based, biodegradable plastic.

Such an adhesive strip may be included in the seal. Alternatively, the adhesive strip may be provided to make a seal. The adhesive strip, if provided, may already be located on the seal. Alternatively, the adhesive strip may be stored separately from the seal and inserted only when the seal is made. Until it is used, the adhesive strip can be covered with a protective layer. The protective layer may be peelable. Such a peelable protective layer on an adhesive layer is also called a peel-off layer.

It is equally important to emphasise that the term seal band 03 is a strand-shaped element with a greatest extension.

The strand-shaped element can be formed with any geometry of its cross-section transverse to the extension of the strand.

The term band in this context does not restrict the cross-section to a flat geometry, nor to a circular geometry.

In the presence of a flat geometry, the ribbon would be most describable as a strip.

In the presence of a circular geometry, the ribbon would most likely be describable as a rope or a string or a wire.

For the present seal 01, both the mentioned and the intermediate geometries of the cross-section of the strand-shaped element can be used.

The seal tape 03 can be designed to be flexible, elastic, soft or rigid, without restricting the basic usability of the seal 01.

Seal 01 achieves the objective of minimising any harmful impact on the surrounding area.

Such a harmful impact on the environment is usually achieved by a spontaneous entry of a no longer needed seal 01 into the environment. Proper disposal of a conventional seal also leads to environmental pollution.

It should be noted that spontaneous entry cannot be excluded in principle.

Due to the biodegradable design of the seal, the impact on the environment is hardly harmful.

Advantageously, the seal body 02 is detachably connectable to at least two portions of the seal band 03 spaced apart from each other around the circumference of the loop 30.

In an operational state shown in FIG. 10, FIG. 11, FIG. 12, FIG. 13, the seal body 02 is undetachably sealable to the portions of the seal band 03. These are at least two parts spaced apart around the circumference of the loop 30.

The sections of the seal 03 spaced apart by the circumference of the loop 30 are the end sections 31, 32 of the seal 03.

An advantageous embodiment of the seal 01 provides that the seal body 02 consists of two parts 21, 22. These parts can be sealed together in a non-detachable manner in an operating state.

Particularly preferably, the seal body 02 consists of two parts 21, 22 which can be connected to each other in an articulated manner.

The two parts 21, 22 which can be connected to each other in a non-detachable sealable manner in an operating state shown in FIG. 10, FIG. 11, FIG. 12 and FIG. 13 can be bonded to each other.

This serves to produce a seal using seal 01.

In this case, it is transferred from its initial state shown in FIG. 1, FIG. 2, FIG. 3, FIG. 4, FIG. 5 to its intermediate state shown in FIG. 6, FIG. 7, FIG. 8, FIG. 9.

Initially, only one end section 32 is fixed to the seal body 02.

For this purpose, the other end section 31 is passed through two opposite openings and laid to form a bay.

Subsequently, the seal band 03 is fixed into a loop 30 by means of the seal body 02.

The operating state of seal 01 is shown in FIG. 10, FIG. 11, FIG. 12, FIG. 13.

The elements that move away from each other when opened can, for example, be part of a closure of a container or device to be sealed.

An adhesive layer can be used for fixing, which is placed between the parts shown together in FIG. 10, FIG. 11, FIG. 12, FIG. 13.

The loop 30 is dimensioned in such a way that it can only be irreversibly destroyed.

Removing the seal 1 is necessary, for example, to gain access to a container content or to a device, or to change a setting.

Advantageously, the end portion 32 is arranged between the two parts 21, 22 of the seal body 02.

The other part, for example the end part 31, passes through a first part 21 of the two parts 21, 22 of the seal body 02. The seal body 02 can be firmly connected to the latter.

The first part 21 can have at least two through openings 23, 24 with a groove 25 in between. The openings 23, 24 are adapted to the dimensions of the sealing strip 03.

The sealing tape 03 is used here as a flexible means and/or flexible strip with two end sections, such as a rope and/or a chain.

The continuous openings 23, 24 with the groove 25 in between are preferably adapted to the cross-sectional dimensions of the sealing strip 03.

Advantageously, the seal body 02 protrudes in the operating state (shown in FIG. 10, FIG. 11, FIG. 12, FIG. 13). The seal body 02 is designed as a seal 01 that can be used as a seal.

The seal body 02 may be designed with parts 21, 22 hingedly connected to each other.

The two parts 21, 22 may be in the form of book covers.

This is a book cover which has two bending strips 23 along a spine.

A first lot, e.g. end lot 32 of the seal band 03, may be defined in a first book cover or on the bending strip 20.

In the first part 21, openings 23, 24 merging into each other are additionally provided by means of the groove 25 (of a lead-through channel). The openings 23, 24 are provided in the form of lead-through openings for the remaining part of the sealing tape 03.

Wedges projecting into the remaining book cover can be arranged opposite the feed-through channel. These wedges can form a labyrinth in the passageway when the book covers are folded together.

When the two parts 21, 22 are folded together and, for example, glued to each other, the labyrinth is fixed in the feed-through channel.

The remaining lot is the remaining final lot 31 of seal tape 03.

This can create an ecological indicative seal in the form of a seal 01 made of biodegradable materials.

This indicative seal comprises a flexible element that can be fixed into a loop 30 as a sealing band 03.

The indicative seal comprises a base in the form of a mirror-symmetrical leaf. The leaf is formed with an inner and outer surface as a seal body 02, the base of which can be bent inwards.

The base consists of the first and second parts 21, 22.

The first and second parts 21, 22 are separated along the line of symmetry by a bending strip 20.

An end portion 32 of the flexible element is attached to the inner surface of the bending strip 20.

In the first part 21 of the base, two openings 23, 24, also briefly referred to as holes, are formed.

The openings 23, 24 are provided for pulling through a free remaining other end portion 31 of the flexible element.

The end section 31 serves to transfer the seal 01 from its initial state (FIG. 1, FIG. 2, FIG. 3, FIG. 4, FIG. 5) via its intermediate state (FIG. 6, FIG. 7, FIG. 8, FIG. 9) to its operating state (FIG. 10, FIG. 11, FIG. 12, FIG. 13).

Starting from the initial state, the sealing can be produced.

A plate with a thickness is attached to the inner surface of the first part 21 of the base. The plate does not exceed the thickness of the flexible element.

A groove 25 is made in the plate.

This comprises the holes for pulling through a free remaining end portion 31 of the flexible comprehensive element during sealing.

A layer of adhesive with residual tack is applied to the inner surface of the second part 22 of the base. This adhesive layer is covered with a protective peel-off layer.

The outer surface of the parts 21, 22 of the base is such that an identification or other type of information can be applied to it.

Perforations 26 may be formed in the base, for example in the first part 21, between the holes.

It is important to emphasise that an opening 23, 24 with a groove 25 is provided for each end portion 31, 32 of the sealing strip 03. This groove 25 is formed up to an opposite edge.

Hereby, both end portions 31, 32 of the sealing strip 03 are inserted into their own groove 25 through their own opening 23, 24 for sealing.

When the two parts 21, 22 of the seal body 02 are folded together, these parts 21, 22 are fixed in their respective own groove 25.

This also creates an ecological indicative seal in the form of a seal 01 made of biodegradable materials.

This indicative seal also comprises, as a sealing band 03, a flexible element which can be fixed into a loop 30.

This indicia seal also comprises a base in the form of a mirror-symmetrical sheet having an inner surface 202 and an outer surface 201.

The base of this indicative seal can also be bent inwards.

The base consists of the first part 21 and the second part 22.

The first part 21 and the second part 22 are separated along a line of symmetry by a bending strip 20.

An end portion 32 of the flexible element is attached to the inner surface of the bending strip 20.

The sheet may be a seal body jacket 200, (FIG. 14, FIG. 15, FIG. 16).

A plate is attached to the inner surface as the first part 21 of the base.

The plate may be a seal core 203 (FIG. 14, FIG. 15, FIG. 16).

Two through holes are formed in the plate for pulling through a remaining free end portion 31. The end portion 31 is flexible and may be formed into an element shaped as a loop.

A recess is formed between the holes. The recess is preferably in the form of a recessed groove 25. This allows the loop 30 to be fixed when sealed.

A through groove 25 is also formed for each hole, leading from the hole to the next edge of the base.

A layer of adhesive with residual tack is applied to the inner surface of the second part 22 of the base.

This is covered with a protective tear-off layer.

The peel ply has a protective layer (FIG. 14c, FIG. 15 and FIG. 16).

The outer surface of the base is designed with the possibility of applying an identification or other type of information, a biodegradable protective label or an RFID label, to it.

Such an outer surface may, for example, be an outer surface 201 of the seal body casing 200 mentioned in the shown embodiments (FIG. 14, FIG. 15, FIG. 16).

In the case of the seal 01 (FIG. 14, FIG. 15, FIG. 16), the seal body 02 comprises three parts 21, 22 which can be connected to one another in a non-detachable manner in an operating state.

The sealing strip 03 is arranged with a first portion, preferably with a first end portion 32 between a first part 21 and a second part 22 of the sealing body 02.

Advantageously, the first end section 32 is arranged in the area of a bending strip 20.

The bending strip 20 connects the first part 21 to the second part 22. The second part 22 comprises two second parts 28, 29 connected to each other by another bending strip 20.

The seal body 02 (FIG. 14, FIG. 15, FIG. 16) comprises a seal body jacket 200.

This can be provided with information on its outer surface 201 (FIG. 14a). This information is shown with a schematically recognisable control number (FIG. 16).

An inner surface 202 opposite the outer surface 201 of the seal body jacket 200 may also be provided with information.

This can be, for example, instructions on how to make the seal, for example in a step-by-step numbering sequence.

A seal core 203 is arranged on the inner surface 202 of the seal body jacket 200.

Advantageously, the seal core 203 is arranged in the region of the portion encompassed by the second part 22 of the seal body 02.

Particularly advantageously, the seal core 203 can be attached to the inner surface 202 of the seal body jacket 200 by means of a seal core adhesive sheet 204. For this purpose, the seal core adhesive sheet 204 is arranged between the seal core 203 and the inner surface 202 of the seal body jacket 200.

Furthermore, another seal core adhesive sheet 205 may be arranged on the side of the seal core 203 facing away from the seal core adhesive sheet 204.

The seal core adhesive sheet 204 is a first seal core adhesive sheet 204. The seal core adhesive sheet 205 is a second seal core adhesive sheet 205.

Several second seal core adhesive sheets 205 can be provided to ensure a particularly tamper-proof seal (FIG. 15).

It is important to note that the term adhesive sheet is representative of a large number of conceivable designs of adhesive layers.

Advantageously, however, at least the second seal core adhesive sheet 205 is an adhesive layer covered, for example, by a peelable protective layer until it is used.

A covered adhesive layer is represented, for example, by a peel-off tab 206 (FIG. 14c, FIG. 15, FIG. 16).

The seal core 203 has circumferential narrow sides 207, 208, 209, 210 as well as an upper and a lower side. These are connected to each other by means of the narrow sides 207, 208, 209, 210.

The seal core 203 is provided with a groove 25. The groove 25 can be designed as a slot in the seal body 203. The groove 25 extends from the top to the bottom of the seal body 203.

The groove 25 leads from a narrow side 207 of the seal core 203 into the seal body 203.

The groove 25 ends in the seal 01 in the seal body 203 before it reaches the narrow side 208 opposite the narrow side 207 (FIG. 14, FIG. 15, FIG. 16).

The groove 25 serves to guide the end section 31 of the sealing strip 03, which is free in the initial state, in the seal body 02.

A mouth widening 211 may be provided to facilitate insertion of the free end portion 31 of the sealing strip 03 into the groove 25.

The seal body jacket 200 may be provided with holes forming apertures 23, 24 in a portion foldable onto the seal core 203 for transfer to the operating condition.

These openings 23, 24, in conjunction with the groove 25, serve to correctly guide the end section 31 of the sealing strip 03.

Advantageously, the portion that can be folded onto the seal core 203 is the portion of the seal body jacket 200 encompassed by the first part 21 of the seal body 02.

One or more additional openings 27 can be used for the additional passage of the end section 31 and/or an external check of its correct passage.

An auxiliary marking may indicate the direction of the end portion 31 of the sealing tape 03 to be guided to form a loop 30 inside the sealing body 02.

In addition, in the unfolded state of the seal body 02 not yet corresponding to the operating state, numbers can be provided, for example, on individual sections of the seal body jacket 200 and/or in the region of the openings 23, 24.

This allows correct passage of the end portion 31 through the seal body 02 by simply following the ascending numbering.

Advantageously, a temperature indicator may be applied to at least the outer surface of one of the parts 21, 22 of the seal body 02, also referred to as the base.

It is important to emphasise that the wedges mentioned can be used in all embodiments of the seal 01.

The wedges are particularly advantageous in connection with a lead-through channel formed, for example, by a groove 25.

In this, the wedges form a labyrinth. The labyrinth immovably fixes one end section 31, 32, preferably the remaining free other end section 31 of the sealing strip 03, in the lead-through channel.

The seal 01 may alternatively or additionally have individual or a combination of several of the described features.

The seal 01 can be used, for example, to seal containers or devices, for example on their housing, for example in the international movement of goods and merchandise, as a customs seal.

It is possible to determine whether a container or appliance has been opened without authorisation after it has been sealed by affixing the seal 01 to the closure of the container or appliance.

The same applies to other uses of seal 01.

It can be used, for example, as proof that a setting made on a device has not been changed, also as a ticket substitute, to render technical connections unusable free of their deactivation, and for military installations.

The invention is not limited by the description based on the embodiments.

Rather, the invention encompasses any new feature as well as any combination of features.

This includes in particular any combination of features in the claims, even if this feature or combination itself is not explicitly stated in the claims or embodiments.

The invention is particularly commercially applicable in the field of the manufacture of customs seals and the like.

The invention is furthermore commercially applicable in the field of the manufacture and operation of installations and devices in which an unauthorised change of a setting or an unauthorised access must be subsequently detectable on the basis of the breaking of a seal.

The invention has been described with reference to preferred embodiments. However, it is conceivable to one skilled in the art that variations or modifications of the invention may be made without departing from the scope of protection of the claims below.

### LIST OF REFERENCE SIGNS

01 Seal
02 Seal body
03 Sealing tape
20 Bending strip
21 Part
22 Part
23 Opening
24 Opening
25 Groove
26 Perforation
27 Opening
28 second part
29 second part
30 Loop
31 Final batch
32 Final batch
200 Seal body casing
201 External surface
202 Inner surface
203 Seal core
204 First seal core adhesive sheet
205 Second seal core adhesive sheet
206 Tab
207 Narrow side
208 Narrow side
209 Narrow side
210 Narrow side
211 Estuary widening

1. Seal with a seal body and a seal band,
wherein at least the seal body consists of a biodegradable material, the seal body is releasably connectable to at least two spaced-apart portions of the seal band and is non-releasably sealable in an operating state, and the seal body consists of at least two parts which are non-releasably sealably connectable to each other in an operating state,
wherein the one portion s arranged between the two parts of the seal body, while the other portion passes through a first part of the two parts and can be firmly connected thereto.

2. Seal according to claim 1,
wherein the biodegradable material consists at least partially of self-compostable material.

3. Seal according to claim 1,
wherein the biodegradable material comprises
a biodegradable plastic and/or
a biodegradable and bio-based plastic and/or
a polylactic acid and/or
Cellulose and/or
Cellulose esters and/or
Celluloid,
wherein the biodegradable material is based on the aforementioned or
wherein this is what the biodegradable material is made of.

4. Seal according to claim 1,
wherein the seal body consists of two parts which can be connected to one another in an articulated manner.

5. Seal according to claim 1,
wherein the two parts which can be connected to one another in a non-detachably sealable manner in an operating state can be bonded to one another.

6. Seal according to claim 5,
wherein an adhesive layer is arranged between the parts which are non-detachably sealed to one another in an operating state.

7. Seal according to claim 1,
wherein a first part of the two parts of the seal body has at least two through-openings with an intermediate groove which are adapted to the dimensions of the seal band and
that in the operating state of the seal at least the other end portion protrudes from the seal body.

8. Seal according to claim 1,
wherein the seal body comprises a seal body jacket and at least one seal core.

9. Seal according to claim 8,
wherein the seal core is provided with a groove.

10. Seal according to claim 9,
wherein the groove, starting from a narrow side of the seal core, ends before reaching an opposite narrow side.

11. Seal according to any one of claim 1,
wherein the groove can be positively connected to the parts.

12. Seal according to any one of claim 1,
wherein the adhesive layer is made of biodegradable material as a two-component adhesive.
